(19) United States
(12) Patent Application Publication
(10) Pub. No.: US 2026/0153213 A1
(43) Pub. Date: Jun. 4, 2026

(54) LIGHTING DEVICE FOR A MOTOR VEHICLE

(71) Applicant: HELLA GMBH & CO. KGAA, Lippstadt (DE)

(72) Inventor: Martin Mügge, Geseke (DE)

(21) Appl. No.: 19/406,427

(22) Filed: Dec. 2, 2025

(30) Foreign Application Priority Data
Dec. 4, 2024 (DE) 102024136023.2

(51) Int. Cl. F21S 43/235; F21S 43/239

(52) U.S. Cl. CPC F21S 43/252; F21S 43/239

(57) ABSTRACT

A lighting device for a motor vehicle. The lighting device includes: a first light source; a first flat light guide, which has an entry surface for light from the first light source and at least one exit surface; a second light source; and a second planar light guide which has an entry surface for light from the second light source and two mutually opposite exit surfaces. The first light guide and the second light guide are arranged one behind the other in the lighting device in such a way that, during operation of the lighting device, light emitted from the exit surface of the first light guide enters one of the exit surfaces of the second light guide and exits from the opposite exit surface of the second light guide. The lighting device includes an optical component, which is designed as an optical disk or as an optical film.

### CROSS-REFERENCE TO RELATED APPLICATIONS

The present application claims the benefit of German Patent Application 10-2024-136-023.2, filed Dec. 4, 2024, the disclosures of which is incorporated by reference.

### FIELD OF THE INVENTION

The present invention relates to a lighting device for a motor vehicle.

### BACKGROUND OF THE INVENTION

Design has long been a determining factor for the signaling functions of a motor vehicle, such as a tail light, a brake light, a direction indicator or a daytime running light, in combination rear lamps or in headlights. The design of these lighting devices has become even more significant since the introduction of LED technology because the small light-emitting diodes, which are often used in larger numbers, can be used much more flexibly than a large incandescent lamp as a light source for a signal function, so that a wide variety of design options are available in conjunction with the selected optical system.

A modification of LED technology is found in the form of OLED technology, in which the light source is not small like a light-emitting diode, but rather has a larger, flat design to form a desired illuminated area that can be illuminated very homogeneously. A disadvantage of OLED technology is the significantly higher cost of OLED technology compared to LED technology. The reasons for these high costs are a complex manufacturing process, the different shapes dictated by the design and small quantities. In addition, there are special, high requirements in the automotive sector, such as resistance to UV exposure and the effects of forces such as vibrations, shocks and shaking, as well as temperature resistance in a region between −40° C. and +85° C. or +100° C. These requirements are substantially more difficult to meet for an organic light-emitting diode than for standard light-emitting diodes.

As a result, alternative options are being sought to achieve a design similar to that of organic light-emitting diodes (OLEDs), in particular a homogeneously illuminated surface. This is achieved by using light-emitting diodes (LEDs) with a flat light guide and upstream optics in the form of microstructured films or thin optical disks to scatter the light emitted from the light guide. Overall, this provides a flat light module that offers high performance with homogeneous illumination of the entire surface.

Just as with organic light-emitting diodes, several flat light modules can then be positioned next to and behind each other when integrated into a combination rear lamp to create the desired individual appearance of the signal function, for example the tail light or tail/stop light. Finally, a flat light module instead of individual modules can also be designed as a large flat light element. As such a flat lighting device, it can also be used to backlight displays.

A lighting device designed as a flat light module is known from DE 10 2022 113 052 A1. The lighting device described therein comprises at least one light source designed as a light-emitting diode (LED) and a flat light guide with an entry surface and at least one exit surface, the entry surface being designed as the front face of the light guide. The lighting device further comprises at least one optical disk. The lighting device is designed so that the light generated by the at least one light source enters the light guide at least partially through the entry surface, so that the light entering through the entry surface exits at least partially from the at least one exit surface, and so that the light emitted from the at least one exit surface of the light guide passes at least partially through the at least one optical disk.

An exemplary lighting device designed as a flat-light module according to this prior art is shown in FIG. 14 and FIG. 15. This flat light module comprises a light source 1 that has several light-emitting diodes (LEDs). The flat light module also comprises a housing 2 with a rear and a front housing part 2a, 2b, which are connected to one another by a latching mechanism. A plate-shaped light guide 3 with micro-optics, a white, diffusely reflective film 4 behind the light guide 3 and two or three optical components 5a, 5b designed as micro-optic films in front of the light guide 3 are inserted between the housing parts 2a, 2b, which together are responsible for the light distribution and efficiency of the system by coordinating the individual micro-optics components. The principle of this basic structure is to provide a light element with a uniform, homogeneously illuminated surface. For this purpose, the lighting device comprises a cover disk 6, which serves as the illuminated exit surface of the lighting device.

The optical component 5a adjacent to the light guide 3 is designed as a diffuser, whereas the second optical component 5b is designed as a so-called BEF optical system. BEF in this context means “Brightness Enhancement Film.” The BEF optical system is therefore used to increase the brightness of the light passing through the optical component 5b. The BEF optical system can be realized on a film or as a thin injection-molded optical disk. Systems with two BEF optical systems, aligned orthogonally to each other, may likewise be provided, in which case the diffuser optical system is sometimes omitted.

The design of today's combination rear lamps is characterized by very homogeneously illuminated areas of the signal function. A signal function such as the tail light is often formed by several illuminated areas. At the same time, the overall size, in particular the height of the rear lamp, is increasingly limited or is becoming smaller and smaller, which is why an intelligent use of the available installation space is important.

### SUMMARY OF THE INVENTION

The problem underlying the present invention is the creation of a lighting device which, in comparison with the lighting device described, has a higher luminous efficacy and/or performance without excessively increasing the power consumption, wherein the lighting device is intended, in particular, to enable new design and construction variants.

According to the invention, this is achieved by a lighting device of the type mentioned at the beginning with the features of embodiments disclosed herein. According to one emobdiment, the lighting device includes: at least one first light source; at least one first flat light guide, which has an entry surface for the light emitting from the at least one first light source and at least one exit surface for light entering the first light guide; at least one second light source; at least one second flat light guide, which has an entry surface for the light emitting from the at least one second light source and two mutually opposite exit surfaces for light entering the second light guide, wherein the at least one first light guide and the at least one second light guide are arranged one behind the other in the lighting device, in such a way that, during operation of the lighting device, light emitted from the at least one exit surface or one of the exit surfaces of the at least one first light guide enters one of the exit surfaces of the at least one second light guide and exits from the opposite exit surface of the at least one second light guide; and at least one optical component which is designed as an optical disk or as an optical film, the lighting device being set up so that the light emitted from the at least one exit surface or one of the exit surfaces of the at least one first light guide or the light emitted from one of the exit surfaces of the at least one second light guide passes at least partially through the at least one optical component and/or is reflected by the at least one optical component.

It may be provided that the at least one first and the at least one second light source can be controlled independently of each other so that they can be switched on and off independently of each other, in particular where the light sources are designed as light-emitting diodes (LEDs). This design has the advantage over the described state of the art that both light guides can be operated or illuminated together and/or independently of each other. If both light guides are illuminated, both emit their light components forwards out of the lighting device. The advantage over the previous principle of a lighting device with a light guide, in which the current for the light-emitting diodes and thus the power consumption must be increased to achieve a higher light output and intensity, is that the second light-emitting diodes, in particular a plurality of second light-emitting diodes, and the second light guide result in an overall lower power consumption even if the current for the light-emitting diodes of the first and second light sources remains low. For a function with low brightness and intensity requirements, such as a tail light or position light, only one light guide can be operated, with the lowest power consumption. Low power consumption is generally an important aspect for future lighting devices in order to realize sustainable systems with a low CO2 foot print. In addition, it is possible to add additional light colors to the respective circuit boards using corresponding light-emitting diodes, thereby enabling the system to produce multiple colors or adding a further light function.

It may be provided that the at least one first light guide and the at least one second light guide are arranged one behind the other in a direction that corresponds to the direction in which the two exit surfaces of the at least one second light guide are opposite each other. In particular, the at least one first light guide can also have two exit surfaces that are opposite each other in the direction in which the light guides are arranged one behind the other. This arrangement of the light guides means that the light emitted from the exit surface of the first light guide facing the second light guide can be effectively coupled into the second light guide and at least partially illuminate the second light guide.

There is the possibility that the at least one first light guide and the at least one second light guide have essentially the same extension in at least one transverse direction, which is aligned perpendicular to the direction in which the two exit surfaces of the at least one second light guide are opposite each other, or that the at least one first light guide has a different extension than the at least one second light guide in at least one transverse direction, which is aligned perpendicular to the direction in which the two exit surfaces of the at least one second light guide are opposite each other. Furthermore, it may be provided that the lighting device comprises at least two first light guides and/or at least two second light guides. By using light guides of different sizes or several first and/or several second light guides, the lighting device can provide additional options for using a flat light system. In particular, partial light emission areas that deviate from the complete surface of a flat light system are enabled, which can be arranged on the left and right in the case of several first or second light guides in the transverse direction of the vehicle, for example. The lighting device offers the possibility of using a flat-light approach to address the issue of multiple, homogeneous illuminated surfaces, in particular partial, homogeneous illuminated surfaces, as well as the intelligent, multiple use of the installation space and also to ensure a low installation depth of the lighting device. Using less material with smaller and more compact lighting devices is an important starting point for sustainability and reduction of the CO2 footprint.

It may be provided that the entry surface of each of the light guides is designed as the end face of the light guide, in particular wherein the lighting device comprises a plurality of first light sources and/or a plurality of second light sources. Particularly in the case of a light guide that is comparatively extended in the transverse direction of the vehicle, a plurality of light-emitting diodes arranged next to each other in the transverse direction of the vehicle can be provided in front of the end face of the light guide, which can be arranged on a common printed circuit board, for example.

It is possible that the lighting device comprises a cover disk, wherein the lighting device is set up so that the light emitted from the at least one exit surface of the at least one second light guide, possibly after passing through the at least one optical component, exits at least partially through the cover disk from the lighting device. The cover disk can be provided with a structure such as a diffuser optical system. In this way, the cover disk can likewise contribute to shaping the light, in particular to homogenizing the light.

It may be provided that at least one of the optical components is arranged between the at least one second light guide and the cover disk and/or that at least one of the optical components is arranged between the at least one first light guide and the at least one second light guide and/or that at least one of the optical components is arranged on the side of the at least one first light guide facing away from the at least one second light guide. It may be provided that the at least one optical component is designed as a microstructured optical disk or as a microstructured optical film. Preferably with several optical components, these can together contribute to the light shaping in the lighting device, in particular to the homogeneous illumination of the exit surface of the lighting device.

There is the possibility that at least one optical component or one of the optical components is designed as a diffuser. A diffuser optical system allows the light to be suitably scattered.

It may be provided that the at least one optical component or one of the optical components is used to increase the brightness of the light passing through the optical component in sections, in particular where the optical component is designed as a BEF optical system. BEF in this context means “Brightness Enhancement Film”. In order to realize a BEF optical system, it can be provided that the at least one optical component or at least one of the optical components has an array of roof prisms.

It is possible that a first surface of the at least one optical component or a first optical component is provided with a diffuser optical system and that a second surface of the at least one optical component or a second optical component is provided with an array of roof prisms. A diffuser optical system allows the light to be suitably scattered to improve the homogeneity of the illuminated surface. The BEF optical system can increase the brightness of the light passing through the optical component. Both surfaces or optical components together can ensure efficient illumination of the exit surface of the lighting device.

It may be provided that the at least one optical component is designed as an at least partially reflective surface, which is arranged on the side of the at least one first light guide facing away from the at least one second light guide, wherein the lighting device is arranged such that light emitted from the exit surface of the at least one first light guide facing away from the at least one second light guide strikes the reflective surface, is reflected back from this to the exit surface, and at least partially re-enters the at least one first light guide before it exits from the exit surface facing the at least one second light guide. The effectiveness of the lighting device is increased by the re-entry of the light reflected back from the reflective surface into the first light guide.

There is the possibility that the exit surfaces of the at least one first light guide and the exit surfaces of the at least one second light guide to be parallel to one another, in particular with the at least one microstructured optical film and/or the at least one microstructured optical disk and/or the reflective surface being parallel to the exit surfaces of the light guides, at least in sections. This means that the at least one microstructured optical foil and/or the at least one microstructured optical disk and/or the reflective surface are oriented in the longitudinal direction of the vehicle like the light guides, so that effective light emission in the forward direction is ensured.

It may be provided that the lighting device comprises a housing on or in which the flat light guides and the at least one optical component are arranged.

### BRIEF DESCRIPTION OF THE DRAWINGS

The invention is explained in more detail below with reference to the accompanying drawings. In the drawings:

FIG. 1 is an exploded view of a first embodiment of a lighting device according to the invention;

FIG. 2 is an exploded view of the lighting device according to FIG. 1, rotated relative to FIG. 1;

FIG. 3 is a front view of the lighting device according to FIG. 1;

FIG. 4 is a perspective view of the lighting device according to FIG. 1;

FIG. 5 is a side view of the lighting device according to FIG. 1;

FIG. 6 is a section through the lighting device according to FIG. 1;

FIG. 7 is a section through a second embodiment of a lighting device according to the invention;

FIG. 8 is a section through the lighting device according to FIG. 7 with light beams shown;

FIG. 9 is a further section through the lighting device as shown in FIG. 7 with light beams shown;

FIG. 10 is detailed view according to arrows X in FIG. 9;

FIG. 11 is a section through a third embodiment of a lighting device according to the invention;

FIG. 12 is a section through a fourth embodiment of a lighting device according to the invention;

FIG. 13 is a section through a fifth embodiment of a lighting device according to the invention;

FIG. 14 is a perspective view of a lighting device according to the state of the art; and

FIG. 15 is an exploded view of the lighting device according to FIG. 14.

In the figures, identical or functionally identical parts are marked with the same reference symbols.

### DETAILED DESCRIPTION OF THE CURRENT EMBODIMENT

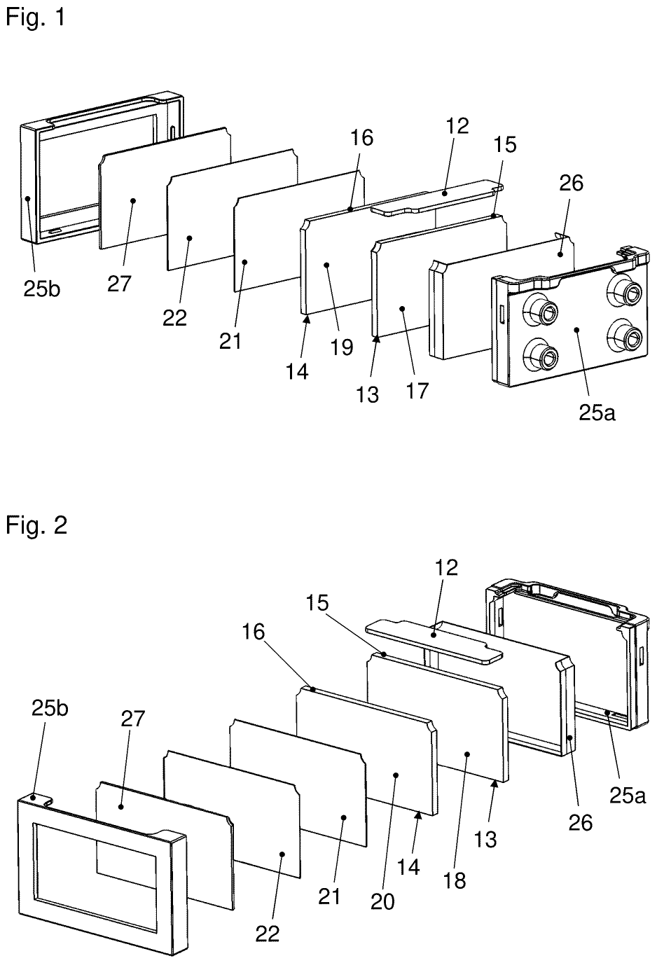

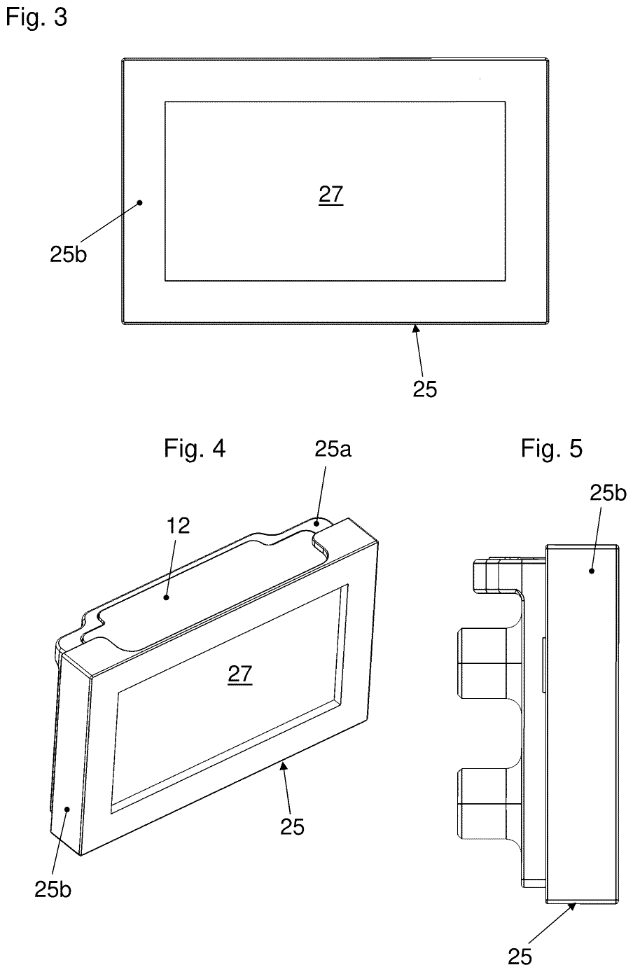

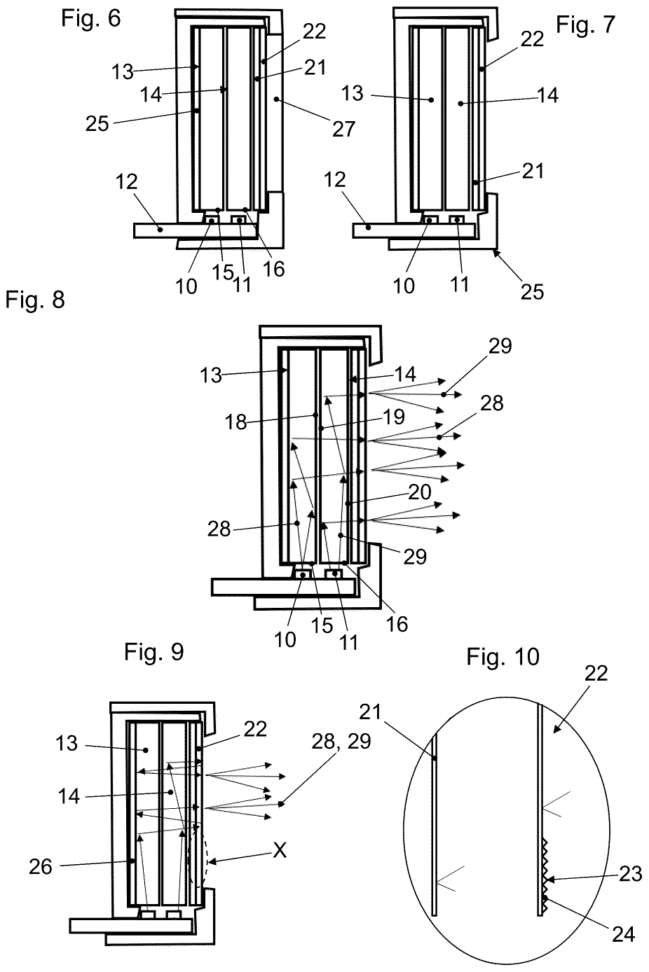

The lighting device shown in FIG. 1 to FIG. 13 comprises several first light sources 10 and several second light sources 11, which are designed as light-emitting diodes (LEDs) (see, for example, FIG. 6). The first light sources 10 and the second light sources 11 can each be arranged next to each other in a row that extends into the drawing plane of FIG. 6. The lighting device comprises a printed circuit board 12 on which the light sources 10, 11, designed as light-emitting diodes, are arranged. In particular, the printed circuit board 12 can be provided with a white solder resist in order to reflect light that is reflected back into the system forwards again (see, for example, FIG. 1, FIG. 2, FIG. 6 and FIG. 7).

The multiple light-emitting diodes can also have different colors, for example to implement a double function or a triple function. For example, LEDs with red and yellow or white and yellow or white and cyan, or bi-color LEDs or RGB LEDs are possible. The functions can be, for example, a position light, a daytime running light and a direction indicator or a position light, a daytime running light and an autonomous driving function, wherein the autonomous driving function requires a cyan color.

The lighting device also comprises a first flat light guide 13 and a second flat light guide 14. Each of the light guides 13, 14 has an entry surface 15, 16, a first exit surface 17, 19, and a second exit surface 18, 20 (see FIG. 1, FIG. 2, and FIG. 6). Each of the entry surfaces 15, 16 is designed as an end face of the respective light guide 13, 14. Each of the first exit surfaces 17, 19 is designed as the front side of the respective light guide 13, 14 and each of the second exit surfaces 18, 20 is designed as the rear side of the respective light guide 13, 14 (see FIG. 1 and FIG. 2). The first and second exit surfaces 17, 18 of the first light guide 13 are arranged opposite each other. Furthermore, the first and second exit surfaces 19, 20 of the second light guide 14 are also arranged opposite each other.

The lighting device further comprises a first optical component 21 arranged in front of the second exit surface 20 of the second light guide 14 and a second optical component 22 arranged in front of the first optical component 21 (see, for example, FIG. 1, FIG. 2, FIG. 6 and FIG. 7). The second optical component 22 is optional and can also be omitted. The optical components 21, 22 can be designed as a microstructured optical disk or as a microstructured optical film.

In the illustrated embodiments, the first optical component 21 has diffuser optics. This diffuser optics can be arranged on the inlet surface and/or on the outlet surface of the first optical component 21.

In the illustrated embodiments, the second optical component 22 has a BEF optical system. FIG. 10 shows an array 23 of roof prisms 24 forming the BEF optical system, which is arranged on the exit surface of the second optical component 22. There is certainly the possibility to alternatively or additionally arrange a BEF optical system on the entrance surface of the second optical component 22. In particular, it may be provided that the arrays 23 of roof prisms 24 on the entry surface and on the exit surface of the second optical component 22 are crossed with respect to each other, i.e. that the ridge lines of the roof prisms 24 on the entry surface extend in a first direction and the ridge lines of the roof prisms 24 on the exit surface extend in a second direction which is perpendicular to the first direction.

The at least one optical component 21, 22 may have a different structuring, which may contribute to the diffuseness and homogenization of the light emitted from the lighting device.

There is the possibility to arrange an optical component not shown, which can be designed as a microstructured optical disk or as a microstructured optical film, between the two light guides 13, 14.

The lighting device also comprises a housing 25 in which the light sources 10, 11, the light guides 13, 14 and the optical components 21, 22 can be at least partially accommodated (see FIG. 1 to FIG. 7). The housing 25 may be designed in two parts for simplified assembly of the optical components, comprising a rear and a front housing part 25a, 25b (see FIG. 1 and FIG. 2). The light guides 13, 14 and the optical components 21, 22 can then be positioned between these housing parts 25a, 25b and held and fixed in place when the two housing parts 25a, 25b are joined together. The housing parts 25a, 25b can be latched together, screwed together from the rear or welded.

The lighting device further comprises a reflective optical component 26 (see FIG. 1 and FIG. 2), which is, for example, a reflective optical film with a reflective surface, wherein the reflective surface in particular has a white surface in order to diffusely reflect the light back. The reflective optical component 26 is bent at the edges. As a result, both the first exit surface 17 of the first light guide 13 and the lateral edges of the first light guide 13 are covered in order to ideally reflect emitted light back into the first light guide 13.

As an alternative to a reflective optical component 26, the rear housing part 25a can also have a rear wall that is at least partially reflective.

The lighting device also comprises a cover disk 27, which is illuminated as homogeneously as possible by the light emitted from the light guide 14 (see FIG. 1, FIG. 2 and FIG. 6). The cover disk 27 can serve as the illuminated exit surface of the lighting device. There is the possibility that the cover disk 27 is designed as a two-component part in one piece with the front housing part 25b (see FIG. 6). Optionally, the cover disk 27 can be omitted (see FIG. 7).

FIG. 8 illustrates that light emitting 28 from the first light sources 10 enters the first light guide 13 through the entry surface 15 and propagates in it. The light 28 propagating through the first light guide 13 can exit through the second exit surface 18 of the first light guide 13 in the direction of the second light guide 14.

Furthermore, light emitting 29 from the second light sources 11 enters the second light guide 14 through the entry surface 16 and propagates in it. The light 29 propagating through the second light guide 14 can exit through the second exit surface 20 of the second light guide 14 to the right in FIG. 8 and leave the lighting device after passing through the optical components 21, 22.

The light 28 emitted from the second exit surface 18 of the first light guide 13 can enter the first exit surface 19 of the second light guide 14. The light 28 entering through the first exit surface 19 of the second light guide 14 can also exit the second light guide 14 through the second exit surface 20 to the right in FIG. 8 and leave the lighting device after passing through the optical components 21, 22. The light emitted from the lighting device is thus a mixture of the light 28, 29 generated by the first light sources 10 and the second light sources 11.

The advantage over the previous principle of a lighting device with a light guide, in which the current for the light-emitting diodes and thus the power consumption must be increased for higher light output and intensity, is that the plurality of second light-emitting diodes and the second light guide 14 result in lower overall power consumption even when the current for the light-emitting diodes of the first and second light sources 10 remains low. 11.

This can be illustrated by the following example calculation of power consumption:

| | Lighting device with | | Lighting device with | |
|---|---|---|---|---|
| | a light guide | | two light guides | |
| Number of LEDs | 9 | | 2 * 9 = 18 | |
| LED current in full | 120 | mA | 50 | mA |
| operation | | | | |
| LED voltage | 3 | V | 3 | V |
| Total power consumption of | 3.24 | W | 2.7 | W |
| the LEDs | | | | |

In a lighting device with a flat light module with one light guide, the LEDs must be operated with a higher current for a brake light, for example, in order to provide the required light, whereas in a lighting device with a flat light module with two light guides, the LEDs can be used with a lower current, resulting in a lower overall power consumption.

At the same time, a flat light module with two light guides offers thermal advantages because the light-emitting diodes with their lower current are distributed over a larger circuit board area, which means that the thermal degradation of the light function is lower than with a flat light module with one light guide and the available light is used more advantageously. Another advantage is to be seen in the fact the light-emitting diodes are also more cost-effective for a lower operating current, which may also save costs overall.

FIG. 9 illustrates that for certain angles of incidence of the light 28, 29 on the BEF optical system of the second optical component 22, back-reflection takes place, in which the light 28, 29 can be reflected back from the second light guide 14 into the first light guide 13. The reflected light passes through the transparent light guides 13, 14 and is reflected forwards again by the rear reflective optical component 26. This light recycling takes place until the angle of incidence of the light 28, 29 on the BEF optical system is in a range that allows the light 28, 29 to pass through and exit to the front. This narrows the angular spread of the light 28, 29 so that the brightness of the light 28, 29 passing through the optical component 22 is increased. It should be noted that this effect can likewise occur in flat light modules with a light guide.

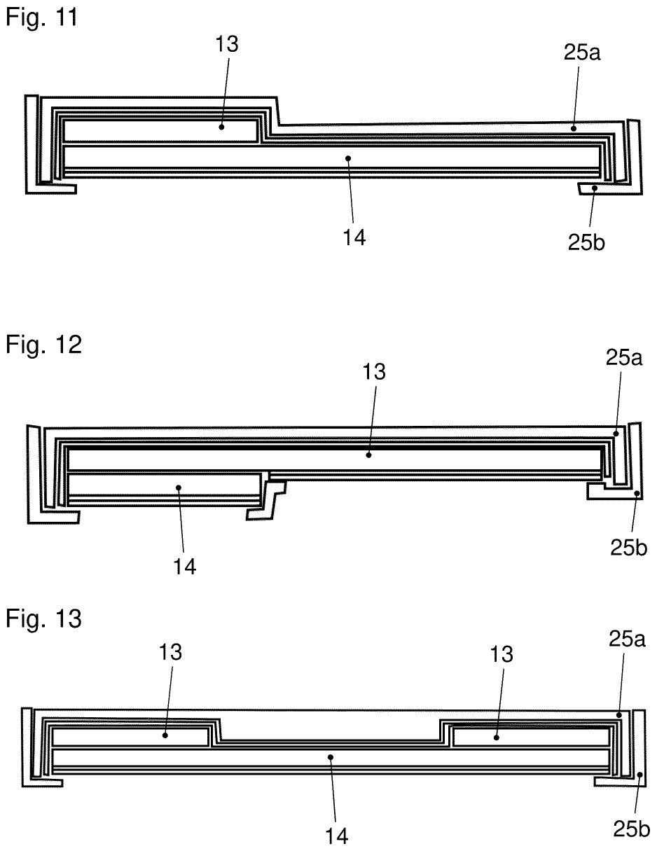

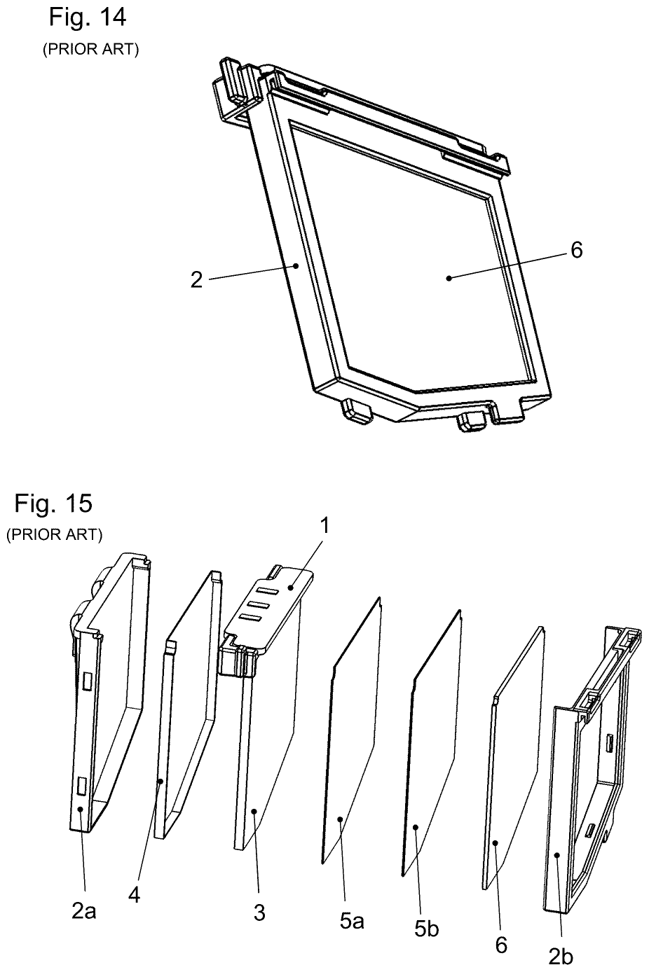

FIG. 11 shows a lighting device in which the first light guide 13 has a smaller extension in the transverse direction of the vehicle than the second light guide 14. The first light guide 13 is connected to the edge of the second light guide 14 on the left-hand side in FIG. 11.

FIG. 12 shows a lighting device in which the first light guide 13 has a larger extension in the transverse direction of the vehicle than the second light guide 14. The second light guide 14 is connected to the edge of the first light guide 13 on the left-hand side in FIG. 12.

FIG. 13 shows a lighting device in which two first light guides 13 are provided, each of which has a smaller extent in the transverse direction of the vehicle than the second light guide 14. The two first light guides 13 are spaced apart from each other in the transverse direction of the vehicle and are each connected to the second light guide 14 at the edge.

Alternatively, there is also the possibility to provide a first light guide 13 and two second light guides 14. Furthermore, more than two first light guides 13 and/or more than two second light guides 14 can also be provided.

The illustrated design examples show flat light guides and optical components. There is definitely the possibility that the light guides and/or the optical components are designed as curved or bent components with curved or bent surfaces.

### LIST OF REFERENCE SYMBOLS

1 light source
2 housing
2a, 2b housing part
3 light guide
4 reflective film
5a, 5b optical component designed as a micro-optical film
6 cover disk
10 first light source
11 second light source
12 printed circuit board
13 first light guide
14 second light guide
entry surface of the first light guide
16 entry surface of the second light guide
17 first exit surface of the first light guide
18 second exit surface of the light guide
19 first exit surface of the second light guide
20 second exit surface of the second light guide
21 first optical component
22 second optical component
23 array of roof prisms
24 roof prism
25 housing
25a rear housing part
25b front housing part
26 reflective optical component
27 cover disk
28 light emitting from the first light source
29 light emitting from the second light source

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, the lighting device comprising:
a first light source;
a first flat light guide, which has an entry surface for light emitting from the first light source and an exit surface;
a second light source;
a second flat light guide, which has an entry surface for light emitted by the second light source and two mutually opposite exit surfaces, wherein the first flat light guide and the second flat light guide are arranged one behind the other such that, during operation of the lighting device, light emitted from the exit surface of the first flat light guide enters one of the exit surfaces of the second flat light guide and exits from the opposite exit surface of the second flat light guide; and
an optical component, which is configured as an optical disk or an optical film, the lighting device being configured such that light emitted from the first flat light guide or light emitted from the second flat light guide passes at least partially through, or is reflected by, the optical component.

2. The lighting device according to claim 1, wherein the first light source and the second light source are controlled independently of each other so they can be switched on and off independently of each other.

3. The lighting device according to claim 1, wherein the first flat light guide and the second flat light guide are arranged one behind the other in a direction that corresponds to the direction in which the two exit surfaces of the second light guide are opposite each other.

4. The lighting device according to claim 1, wherein the first flat light guide and the second flat light guide have the same extension in a transverse direction, which is aligned perpendicular to the direction separating the two exit surfaces of the second flat light guide.

5. The lighting device according to claim 1, further comprising at least two first flat light guides and at least two second flat light guides.

6. The lighting device according to claim 1, wherein the entry surface of the first flat light guide and the entry surface of the second flat light guide are configured as an end face of the first flat light guide and the second flat light guide, respectively.

7. The lighting device according to claim 1, wherein the first flat light guide has two exit surfaces which are arranged opposite of each other.

8. The lighting device according to claim 1, further comprising a cover disk, wherein light emitted from at least one exit surface of the second light guide exits through the cover disk.

9. The lighting device according to claim 8, wherein the optical component is disposed between the second light guide and the cover disk.

10. The lighting device according to claim 1, wherein the optical component is a microstructured optical disk or a microstructured optical film.

11. The lighting device of claim 1, wherein the optical component is light diffusing.

12. The lighting device according to claim 1, wherein the optical component increases the brightness of light passing therethrough as a brightness enhancing film.

13. The lighting device according to claim 1, wherein the optical component includes a reflective surface on a side of the first flat light guide facing away from the second flat light guide, such that light emitted from the first flat light guide strikes the reflective surface, is reflected back to the first flat light guide, and is emitted from the exit surface of the first flat light guide towards the second flat light guide.

14. The lighting device according to claim 10, wherein the optical component is parallel to the exit surfaces of the first and second flat light guide light guides.

15. The lighting device according to claim 1, further comprising a housing in which the first and second flat light guides and the optical component are arranged.
